(19) United States
(12) Patent Application Publication
(10) Pub. No.: US 2023/0419375 A1
(43) Pub. Date: Dec. 28, 2023

(54) DEMAND EQUILIBRIUM BASED PRICING

(71) Applicant: Capital One Services, LLC, McLean, VA (US)

(72) Inventors: Ray Cheng, Long Island CIty, NY (US); Jennifer Kwok, Brooklyn, NY (US); Xiaoguang Zhu, New York, NY (US)

(21) Appl. No.: 17/846,148

(22) Filed: Jun. 22, 2022

(51) Int. Cl. G06Q 30/02

(52) U.S. Cl. CPC G06Q 30/0284; G06Q 30/0201; G06Q 30/0269

(57) ABSTRACT

Disclosed aspects pertain to demand-equilibrium-based pricing. Transaction data associated with a merchant can be utilized to generate and train a pricing model. The pricing model can be invoked to determine a pricing schedule for a set of items offered by the merchant. The pricing schedule can set prices of items based on the time of day and the transaction rate of the merchant. The pricing schedule can be implemented with the merchant through a digital display. The pricing schedule can also be updated such that prices for the items offered by the merchant can change based on the time of day to achieve a target transaction rate through the merchant's business hours.

### BACKGROUND

Merchants, particularly in food and beverage or entertainment, have peak and off-peak hours where business and foot traffic varies greatly. During peak demand, merchants can control certain variables such as head count and having enough supplies. However, when demand surpasses output capacity, merchants cannot expand square footage or immediately add additional equipment or resources to match the demand. When capacity is exceeded, the merchant and potential customers experience lost business and long lines during peak hours. During off-peak demand, merchants can control certain variables such as hours of operation and head count. However, square footage and equipment are underutilized leading to lost opportunity cost due to a lack of transactions or business being processed.

### SUMMARY

The following presents a simplified summary to provide a basic understanding of some aspects of the disclosed subject matter. This summary is not an extensive overview. It is not intended to identify key/critical elements or delineate the scope of the claimed subject matter. Its sole purpose is to present some concepts in a simplified form as a prelude to the more detailed description presented later.

Disclosed embodiments can comprise systems and methods of demand-equilibrium-based pricing. Transaction data associated with a merchant can be compiled. A pricing model can be trained via machine learning with the transaction data. The pricing model can determine a pricing schedule for a set of items the merchant offers. The pricing schedule can set prices of items based on the time of day and the transaction rate of the merchant. The pricing schedule can be implemented with the merchant via a digital display. The pricing schedule can be updated such that prices for the items offered by the merchant can change based on time of day to achieve a steady, constant, or target transaction rate through the merchant's business hours.

According to one aspect, disclosed embodiments can include a system that comprises a processor coupled to a memory that includes instructions that, when executed by the processor, cause the processor to request historical transaction data of a merchant from a financial institution database, compute a historical transaction rate from the historical transaction data, generate a pricing model based on the historical transaction data and historical transaction rate that correlates item price with the historical transaction rate, determine a current transaction rate from real-time transaction data, invoke the pricing model with a current pricing schedule, the current transaction rate to produce an updated pricing schedule for the merchant that adjusts one or more prices to achieve a predetermined target transaction rate, and implement the updated pricing schedule with the merchant on a merchant computing device. In one instance, the pricing model is a machine learning model that infers the updated pricing schedule that is likely to achieve the predetermined target transaction rate. Further, the variance between the current pricing schedule and the updated pricing schedule can be constrained to a predetermined amount and confined by one or more of a predetermined minimum or predetermined maximum price. The updated pricing schedule can also provide different pricing for a set of items offered by the merchant based on a time of day. The instructions can further cause the processor to continuously update the pricing schedule with the pricing model until the target transaction rate is achieved. In one scenario, the target transaction rate can be a constant transaction rate during business hours. Further, the instructions can cause the processor to update the pricing model with the current pricing schedule and the current transaction rate. In one instance, the merchant computing device can be embodied as a digital display that presents prices of items provided by the merchant.

In accordance with another aspect, disclosed embodiments can include a method comprising executing, on a processor, instructions that cause the processor to perform operations. The operations include requesting historical transaction data of a merchant from a financial institution database, computing a historical transaction rate from the historical transaction data, generating a pricing model based on the historical transaction data and historical transaction rate that correlates item price with the historical transaction rate, determining a current transaction rate from real-time transaction data, invoke the pricing model with a current pricing schedule, the current transaction rate to produce an updated pricing schedule for the merchant that adjusts one or more prices to achieve a predetermined target transaction rate, and implementing the updated pricing schedule with the merchant on a merchant computing device. The operations can further comprise generating a machine-learning-based pricing model. The operations can also comprise invoking the pricing model with a variance constraint that restricts variance between the current pricing schedule and the updated pricing schedule to a predetermined amount. Additionally, the operations can comprise invoking the pricing model with a predetermined minimum or predetermined maximum price constraint. The operations can further comprise continuously updating the pricing schedule with the pricing model until the target transaction rate is achieved. Further, the operations can comprise updating the pricing model with the current pricing schedule and the current transaction rate. Furthermore, the operations can further comprise implementing the updated pricing schedule on a digital display that presents prices of items provided by the merchant.

According to yet another aspect, disclosed embodiments can include a computer-implemented method. The method comprises determining a current transaction rate from real-time transaction data of a merchant, comparing the current transaction rate with a target transaction rate, executing a pricing model with a current pricing schedule and a current transaction rates as input to update the pricing schedule for the merchant by adjusting one or more prices to achieve a predetermined target transaction rate, wherein the pricing model correlates item price with historical transaction rates and execution of the pricing model is triggered when a result of the comparing satisfies a threshold difference, and implementing the pricing schedule with the merchant on a merchant computing device. The method can further comprise determining contact information for a set of customers associated with the merchant and sending a notification to the contact information of the set of customers, in which the notification includes an offer based on the pricing schedule. In one instance, the notification can be a targeted advertisement to a set of customers by way of a social media message. Further, the method can comprise interfacing with a delivery service application, wherein the delivery service application includes a set of items provided by the merchant and updating the delivery service application with the pricing schedule for the set of items.

Disclosed aspects can provide substantial benefits in terms of demand-equilibrium-based pricing. One advantage resides in an automated determination of a pricing schedule. Another advantage resides in a constant transaction rate throughout business hours for a merchant.

To accomplish the foregoing and related ends, certain illustrative aspects of the claimed subject matter are described herein in connection with the following description and the annexed drawings. These aspects indicate various ways in which the subject matter can be practiced, all of which are intended to be within the scope of the disclosed subject matter. Other advantages and novel features may become apparent from the following detailed description when considered in conjunction with the drawings.

### BRIEF DESCRIPTION OF THE DRAWINGS

Aspects of the disclosure are understood from the following detailed description when read with the accompanying drawings. It will be appreciated that elements, structures, and the like of the drawings are not necessarily drawn to scale. Accordingly, the dimensions of the same can be arbitrarily increased or reduced for clarity of discussion, for example.

FIG. 1 illustrates a high-level diagram of disclosed aspects.

FIG. 2 illustrates an example view of a pricing schedule.

FIG. 3 illustrates an example component diagram of a scheduler.

FIG. 4 illustrates an example component diagram of an analysis component.

FIG. 5 illustrates an example method for demand-equilibrium-based pricing.

FIG. 6 illustrates a computing environment where one or more of the provisions set forth herein can be implemented, according to some embodiments.

### DETAILED DESCRIPTION

Aspects of the disclosure are now described with reference to the drawings, wherein like reference numerals are used to refer to like elements throughout. In the following description, for purposes of explanation, numerous specific details are set forth in order to provide a thorough understanding of aspects of the subject disclosure. It may be evident, however, that the aspects can be practiced without these specific details. In other instances, well-known structures and devices are shown in block diagram form to facilitate describing aspects of the disclosure.

As used in this application, the terms “component”, “module,” “system”, “interface”, and the like are generally intended to refer to a computer-related entity, either hardware, a combination of hardware and software, software, or software in execution. For example, a component can be, but is not limited to being, a process running on a processor, a processor, an object, an executable, a thread of execution, a program, or a computer. By way of illustration, both an application running on a controller and the controller can be a component. One or more components residing within a process or thread of execution and a component can be localized on one computer or distributed between two or more computers.

Furthermore, the claimed subject matter can be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications can be made to this configuration without departing from the scope or spirit of the claimed subject matter.

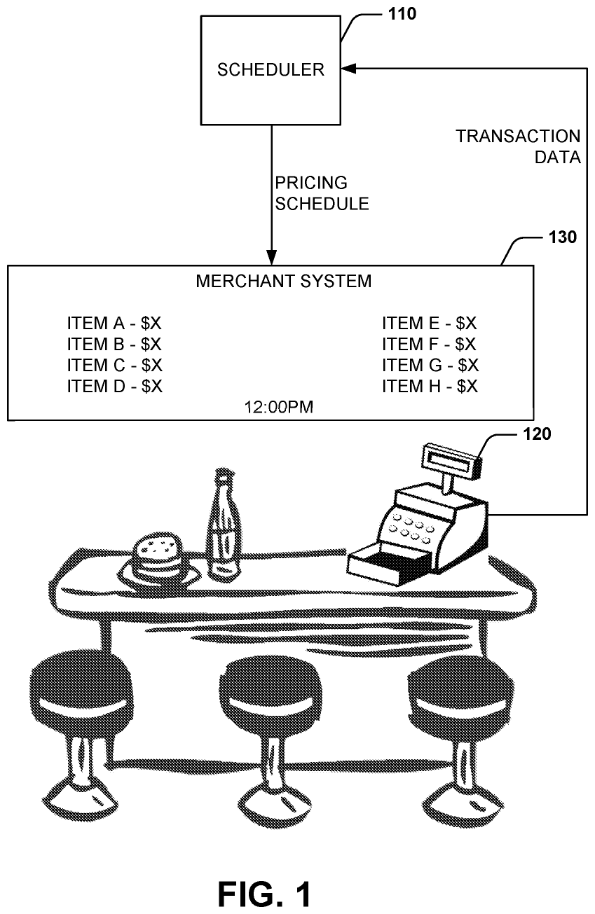

FIG. 1 illustrates a high-level view of the aspects of the subject disclosure. A scheduler 110 can receive or compile transaction data of a merchant 120. The scheduler 110 can be a website portal, application, mobile device, personal computer, service provided by a financial institution, or the like. The merchant 120 can be a retail store or vendor that provides items, goods, or services to customers. The transaction data can be compiled from the merchant 120 or a financial institution. The transaction data can include item identification, amount, time, number of transactions, or transaction rate (e.g., transactions per hour, or item specific transactions per hour).

The scheduler 110 receives or compiles the transaction data. The scheduler 110 analyzes the transaction data of the merchant 120. The scheduler 110 computes metrics regarding the transaction data, such as a transaction rate, a tracking transaction rate in real or near real-time, time-based metrics, or the like. A transaction rate can be the number of transactions per period of time, such as sales per hour. The scheduler 110 can determine a pricing schedule for a set of items offered by the merchant 120. The scheduler 110 determines the pricing schedule based on the transaction data. The scheduler 110 can determine a pricing model based on the transaction data, computed metrics, or both. In some embodiments, the scheduler 110 can train the pricing model with a machine learning technique. In other embodiments, the scheduler 110 can determine the pricing schedule with an optimization algorithm such as a linear regression model with constraints for different variables of the merchant 120 such as time, transaction rate, or the like. A machine learning model can learn the constraints in some embodiments.

The scheduler 110 can invoke the pricing model with the transaction data as an input data set. The scheduler 110 can output a pricing schedule optimized for the merchant 120. The pricing schedule dynamically provides or changes the price for at least one item offered by the merchant 120 according to a time of day, such as to affect demand for the item and increase or decrease a transaction rate for the merchant 120. For example, the pricing schedule can lower an item's price between 2 pm and 3 pm to increase traffic into the merchant 120. The scheduler 110 determines the pricing schedule such that a transaction rate is steady or constant throughout the business hours during which the merchant 120 is open. In some embodiments, the pricing schedule can dynamically change based on present demand or time of day to achieve a steady or constant transaction rate.

The scheduler 110 implements the pricing schedule at the merchant 120. The scheduler 110 can interface with a merchant device 130 or digital display. The scheduler 110 can dynamically implement the pricing schedule with the merchant device 130 in real or near real-time. The scheduler 110 can update one or more prices or an item or a set of items offered by the merchant 120. In some embodiments, the merchant device 130 is a digital display (e.g., a menu screen) that is presented to customers of the merchant 120 for purposes of ordering one or more of the items. For example, a fast-casual or fast food restaurant includes a digital menu board above a register or counter for ordering. The scheduler 110 can change prices or items on the digital display based on the pricing schedule, present demand, transaction rate, or the like.

In some embodiments, the scheduler 110 monitors or compiles new transaction data from the merchant 120. The scheduler 110 can compile the new transaction data in real or near real-time. The scheduler 110 can compute real or near real-time metrics of the new transaction data. The scheduler 110 can compare the new metrics to a goal metric (e.g., a target transaction rate) to determine whether equilibrium is achieved for the merchant. The new metric can track the transaction rate to determine whether the merchant 120 is achieving equilibrium. Equilibrium is achieved when a transaction rate or tracking transaction rate is the rate at which the merchant 120 completes transactions, such that the merchant 120 is not overloaded or under-loaded based on the merchant capacity. For example, suppose the merchant 120 is capable of processing transactions at sixty transactions per hour. The target transaction rate can be sixty transactions per hour. In some embodiments, the merchant 120 can provide the scheduler 110 with the target transaction rate for equilibrium. The scheduler 110 can compare the tracking transaction rate to the target transaction rate to determine whether the pricing schedule should be updated with the pricing model. For example, if the tracking transaction rate is below sixty transactions per hour, the pricing schedule can lower prices to increase the tracking transaction rate. If the tracking transaction rate exceeds sixty transactions per hour, the pricing schedule can raise prices to decrease the tracking transaction rate.

In some embodiments, the scheduler 110 can continuously update the pricing schedule via the pricing model according to the new transaction data until a steady transaction rate or target transaction rate is achieved for the merchant 120. The scheduler 110 can dynamically update the merchant device 130 according to an updated pricing schedule. The scheduler 110 can update the merchant device 130 in real or near real-time.

In some embodiments, the scheduler 110 can interface with a delivery service application or ordering application associated with the merchant 120. The delivery service application includes a set of items provided by the merchant 120. The scheduler 110 can update the delivery service application with the pricing schedule for the set of items based on time of day to optimize traffic at the merchant 120 to achieve a constant transaction rate equal to (or within a threshold of) the target transaction rate.

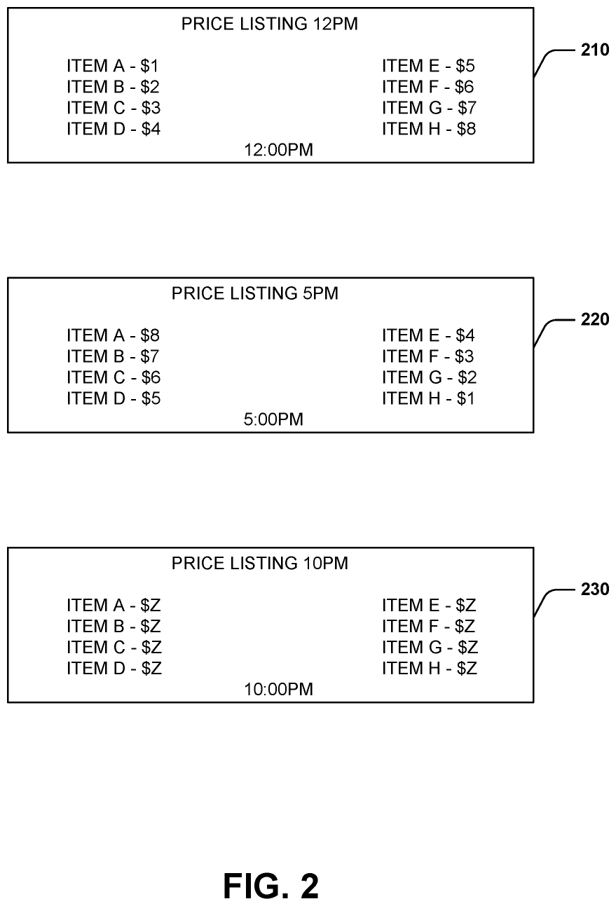

FIG. 2 illustrates an example pricing schedule based on time of day. For example, the merchant 120 can open for business at noon. The scheduler 110 can provide a pricing schedule based on the time of day, traffic, capacity, or the like. The merchant 120 can display or offer a price listing for sale via the merchant device 130. A first price listing 210 lists items for sale at different prices (e.g., $X). For example, the first price listing 210 is effective at noon. The scheduler 110 or the merchant 120 can update the first price listing 210 to a second price listing 220 according to the pricing schedule. The merchant device 130 is updated to display or offer the second price listing 220. The second price listing 220 can update or change prices for one or more items of the set of items for sale. For example, the second price listing 220 comes into effect at 5:00 pm according to the price schedule determined by the scheduler 110. The scheduler 110 or the merchant 120 can update the second price listing 220 to a third price listing 230 according to the pricing schedule. The merchant device 130 is updated to display or offer the third price listing 230. The third price listing 230 can update or change prices for the one or more items of the set of items for sale. For example, the third price listing 230 comes into effect at 10:00 pm according to the price schedule determined by the scheduler 110.

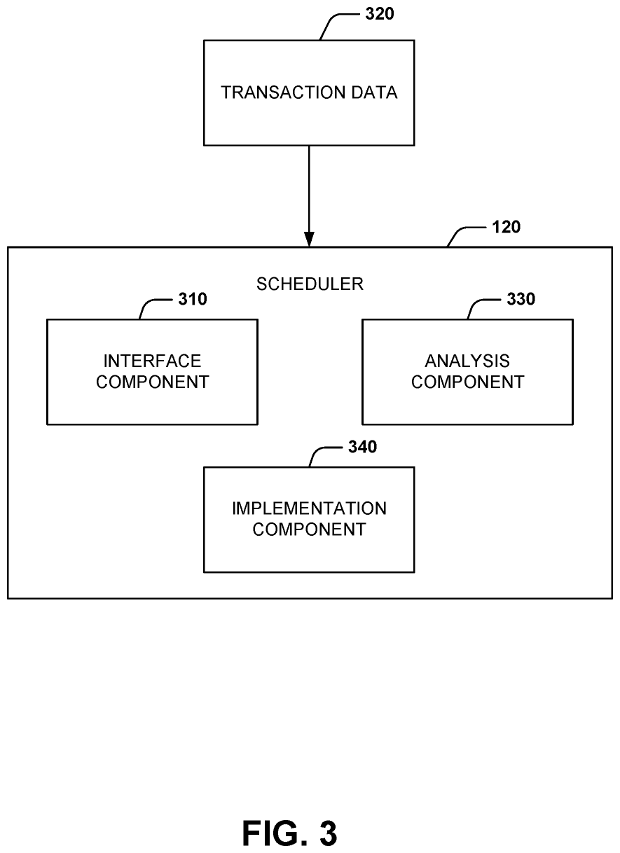

FIG. 3 illustrates a detailed component diagram of the scheduler 110 in accordance with one embodiment. The scheduler 110 includes an interface component 310. The interface component 310 can receive or compile transaction data 320 of a merchant. The interface component 310 compiles transaction data from the merchant 120, financial institution, or both. The transaction data can include item identification, amount, time, number of transactions, or transaction rate (e.g., transactions per hour, or item specific transactions per hour). In some embodiments, the interface component 310 can compile data from other data sources. The interface component 310 can compile traffic data, geolocation data, routing data, perishability data of items or ingredients offered by the merchant 120, transaction data from similar merchants or other locations of the merchant, or the like. In other embodiments, the interface component 310 can map the merchant 120 to determine a capacity or optimized transaction rate. In some embodiments, the interface component 310 can compile user or customer data, for example, a most common item ordered by a customer, a favorite item, or the like. In some embodiments, the interface component 310 can compile events data within a proximity of the merchant 120.

The scheduler 110 includes an analysis component 330. The analysis component 330 can analyze the transaction data of the merchant. The analysis component 330 computes metrics regarding the transaction data, such as a transaction rate, a tracking transaction rate in real or near real-time, time-based metrics, or the like. The analysis component 330 can determine a pricing schedule for a set of items offered by the merchant 120. The analysis component 330 determines the pricing schedule based on the transaction data. The analysis component 330 can determine a pricing model based on the transaction data, computed metrics, or both. The analysis component 330 can implement a trained machine-learning-based pricing model in some embodiments. In other embodiments, the analysis component 330 can determine the pricing schedule via an optimization algorithm such as a linear regression model with constraints for different variables of the merchant such as time, transaction rate, or the like. In yet another embodiment, the constraints can be determined via a machine learning technique.

The analysis component 330 can invoke the pricing model with the transaction data as an input data set. In some embodiments, the analysis component 330 factors further data as inputs for the pricing model, such as traffic data, geolocation data, routing data, capacity mapping, perishability of items, other merchant data, event data, ticketing data, or the like. The analysis component 330 optimizes the pricing schedule according to further data. The analysis component 330 can output a pricing schedule optimized for the merchant 120. The pricing schedule dynamically provides or changes a price for at least one item offered by the merchant 120 according to a time of day, such as to affect demand for the item and increase or decrease a transaction rate for the merchant 120. For example, the pricing model can output a pricing schedule for a time based on a well-attended event that ends at 10:00 pm on a specific day. The analysis component 330 determines the pricing schedule such that a transaction rate is steady or constant throughout the business hours of which the merchant 120 is open. In some embodiments, the pricing schedule can dynamically change based on present demand or time of day to achieve a steady or constant transaction rate equal to the target transaction rate.

In some embodiments, the analysis component 330 can optimize the pricing schedule according to further compiled data such as traffic data, geolocation data, routing data, perishability data of items or ingredients offered by the merchant, transaction data from similar merchants or other locations of the merchant, or the like. For example, the analysis component 330 can determine geolocation data of a set of customers or customer devices. The analysis component 330 can determine if there is a critical mass of customers near the merchant 120 and predict an influx of transactions. The pricing schedule can be adapted in anticipation of an increased transaction rate prediction to maintain or generate a steady or constant transaction rate. In some embodiments, the analysis component 330 can optimize the pricing schedule according to perishability data of ingredients or items of the merchant 120. For example, the analysis component 330 can lower the prices of a fish expiring in two days to ensure that customers are driven toward ordering the fish. In some embodiments, the analysis component 330 can determine routing data such as customers that are navigating to the merchant 120. The analysis component 330 can predict an influx of transactions based on the routing data of customers. The pricing schedule can be adapted in anticipation of an increased transaction rate prediction to maintain or generate a steady or constant transaction rate. In other embodiments, the analysis component 330 can determine a high transaction rate for a nearby merchant. The analysis component 330 can predict a possible influx of customers or a possible effluence of customers based on the transaction rate of a competing or nearby restaurant. The pricing schedule can be adapted accordingly based on a predicted influx or effluence.

The scheduler 110 can include an implementation component 340. The implementation component 340 implements the pricing schedule at the merchant 120. The implementation component 340 can interface with a merchant device 130 or digital display. The implementation component 340 can dynamically implement the pricing schedule with the merchant device 130 in real or near real-time. The implementation component 340 can update one or more prices or an item or set of items offered by the merchant 120. In some embodiments, the merchant device 130 is a digital display (e.g., a menu screen) that is presented to customers of the merchant 120 for purposes of ordering one or more of the items. For example, a fast-casual or fast food restaurant can include a digital menu board above a register or counter for ordering. The implementation component 340 can change prices or items on the digital display based on the pricing schedule, present demand, transaction rate, or the like.

In some embodiments, the implementation component 340 can implement the pricing schedule as an offer or advertisement-based implementation. The implementation component 340 can determine a set of customers or potential customers of the merchant 120. The set of customers, for example, can be customers that have previously transacted with the merchant 120. The implementation component 340 can determine contact information of the set of customers. The implementation component 340 can provide a targeted advertisement, a flash sale, a coupon code, or the like to the contact information of the set of customers. The implementation component 340 can provide an offer by email, text, social media, directed marketing, or other communication means.

In some embodiments, the implementation component 340 or the interface component 310 can monitor or compile new transaction data from the merchant 120. The interface component 310 can compile the new transaction data in real or near real-time. The interface component 310 can compute real or near real-time metrics of the new transaction data. The analysis component 330 can compare the new metrics to a goal metric to determine whether equilibrium is achieved for the merchant. The new metric can be a tracking transaction rate to determine whether the merchant 120 is achieving equilibrium. Equilibrium is achieved when a transaction rate or tracking transaction rate is the rate at which the merchant 120 completes transactions so that the merchant 120 is not overloaded or under-loaded based on the merchant capacity. In some embodiments, the merchant 120 can provide the analysis component 330 with a target transaction rate for equilibrium. The analysis component 330 can compare the tracking transaction rate to the target transaction rate to determine whether the pricing schedule should be updated via the pricing model. In some embodiments, the implementation component 340 can continuously update the pricing schedule via the pricing model according to the new transaction data until a steady transaction rate or target transaction rate is achieved for the merchant 120. The implementation component 340 can dynamically update the merchant device 130 according to an updated pricing schedule. The implementation component 340 can update the merchant device 130 in real or near real-time.

In some embodiments, the implementation component 340 can interface with a delivery service application or ordering application associated with the merchant 120. The delivery service application includes a set of items provided by the merchant 120. The implementation component 340 can update the delivery service application with the pricing schedule for the set of items based on time of day to optimize traffic at the merchant 120 to achieve a steady transaction rate or target transaction rate.

In other embodiments, the implementation component 340 can interface with a reservation service application associated with the merchant. The reservation service application includes a portal through which customers can reserve a table or attendance at the merchant 120. The implementation component 340 can provide ad hoc offers to customers based on their reservation data to change an upcoming reservation according to the pricing schedule. The implementation component 340 can offer to change reservations (or schedule a new reservation at) to an off-peak time based on the pricing schedule to maintain a steady or constant transaction rate.

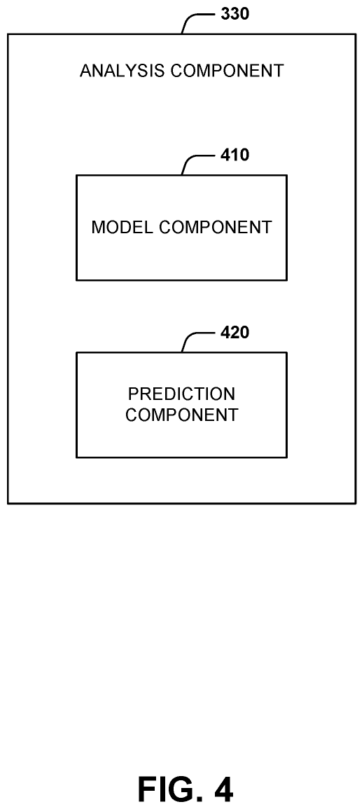

FIG. 4 illustrates an example component diagram of analysis component 330. The analysis component 330 includes a model component 410. The model component 410 analyzes the transaction data of the merchant. The model component 410 can determine a pricing model based on the transaction data, the computed metrics, or both. In some embodiments, the model component 410 can train the pricing model via a machine learning technique. In other embodiments, the model component 410 can determine the pricing schedule via an optimization algorithm such as a linear regression model with constraints for different variables of the merchant such as time, transaction rate, or the like. In some embodiments, machine learning techniques can determine the constraints.

In some embodiments, the model component 410 determines a pricing model based on an analysis of the transaction data of the merchant 120. The model component 410 can train the pricing model via transaction data associated with the merchant 120. The model component 410 can utilize a machine learning technique to determine a pricing model that can output a pricing schedule for the merchant 120. The model component 410 learns from existing data to predict the pricing schedule. The model component 410 builds the pricing model from the transaction data, computed metrics (e.g., “training data set”), or both to make data-driven predictions or decisions expressed as outputs or assessments for a pricing schedule. The model component 410 can determine the trends or correlations within the transaction data. In some embodiments, the model component 410 utilizes the machine learning technique to analyze the transaction data across different merchants, locations, or the like to determine a pricing model based on correlations in the transaction data. For example, the pricing model can determine a trend between a time of day, an item price, and a transaction rate. The model component 410 can receive transaction data as an input for the pricing model. The model component 410, via the pricing model, can output a pricing schedule based on the transaction data for the merchant 120.

The analysis component 330 includes a prediction component 420. The prediction component 420 can invoke the pricing model with the transaction data as an input data set. The prediction component 420 can output a pricing schedule optimized for the merchant 120. The pricing schedule dynamically changes a price for at least one item offered by the merchant 120 according to a time of day, such as to affect demand for the item and increase or decrease a transaction rate for the merchant 120. For example, the pricing schedule can lower an item's price between 2 pm and 3 pm to increase traffic into the merchant 120. The prediction component 420 determines the pricing schedule such that a transaction rate is steady or constant throughout the business hours of which the merchant is open. In some embodiments, the pricing schedule can dynamically change based on present demand or time of day to achieve a steady or constant transaction rate.

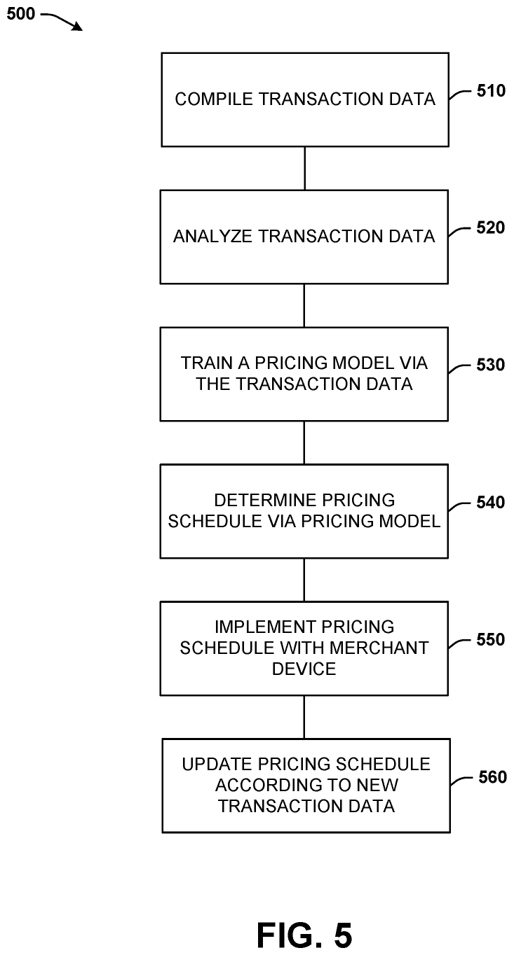

With reference to FIG. 5, example method 500 is depicted for demand-equilibrium-based pricing. While, for purposes of simplicity of explanation, the methods are shown and described as a series of acts, it is to be understood and appreciated that the subject disclosure is not limited by the order of acts, as some acts can occur in a different order or concurrently with other acts from that shown and described herein. For example, those skilled in the art will understand and appreciate that a method could alternatively be represented as a series of interrelated states or events, such as in a state diagram. Moreover, not all illustrated acts may be required to implement a method. It is also appreciated that the method 500 is described in conjunction with a specific example for explanation purposes.

FIG. 5 illustrates a method 500 for demand-equilibrium-based pricing. At 510, transaction data can be compiled. A scheduler 110 can access or interface with a merchant 120 to retrieve or compile transaction data. The transaction data can include time, amount, item or service purchased, location, event data, a transaction rate, or the like. At 520, the transaction data is analyzed. The scheduler 110 can analyze the transaction data to determine or compute metrics based on the transaction data, such as a transaction rate or tracking transaction rate. The scheduler 110 can analyze the transaction data to determine peak and off-peak hours. The scheduler 110 can further analyze the transaction data to determine a target transaction rate representative of capacity of the merchant 120.

At 530, a pricing model can be trained. The scheduler 110 can train the pricing model via the transaction data. The scheduler 110 can train the pricing model via a machine learning technique. The scheduler 110 can determine constraints for a linear regression model. At 540, the pricing model can determine a pricing schedule. The scheduler 110 can determine the pricing schedule for a set of items offered by the merchant 120. The scheduler 110 can invoke the pricing model with transaction data as the input to output the pricing schedule. At 550, the pricing schedule is implemented. The scheduler 110 can provide the pricing schedule to a merchant device 130, such as a digital display. The scheduler 110 can update the pricing schedule such that prices for a set of items offered by the merchant 120 can change based on time of day to achieve a steady or optimal transaction rate through the merchant's business hours. At 560, the pricing schedule is updated according to new transaction data. The scheduler 110 can compile new transaction data to determine whether the pricing schedule should be updated. For example, the new transaction data can reveal that a target transaction rate has not been achieved for the merchant 120. The scheduler 110 can update the pricing schedule that adjusts price listings of the set of items to achieve the target transaction rate at the capacity of the merchant 120.

As used herein, the terms “component” and “system,” as well as various forms thereof (e.g., components, systems, sub-systems) are intended to refer to a computer-related entity, either hardware, a combination of hardware and software, software, or software in execution. For example, a component can be, but is not limited to being, a process running on a processor, a processor, an object, an instance, an executable, a thread of execution, a program, and/or a computer. By way of illustration, both an application running on a computer and the computer can be a component. One or more components can reside within a process and/or thread of execution, and a component can be localized on one computer and/or distributed between two or more computers.

The conjunction “or” as used in this description and appended claims is intended to mean an inclusive “or” rather than an exclusive “or” unless otherwise specified or clear from context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the foregoing instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

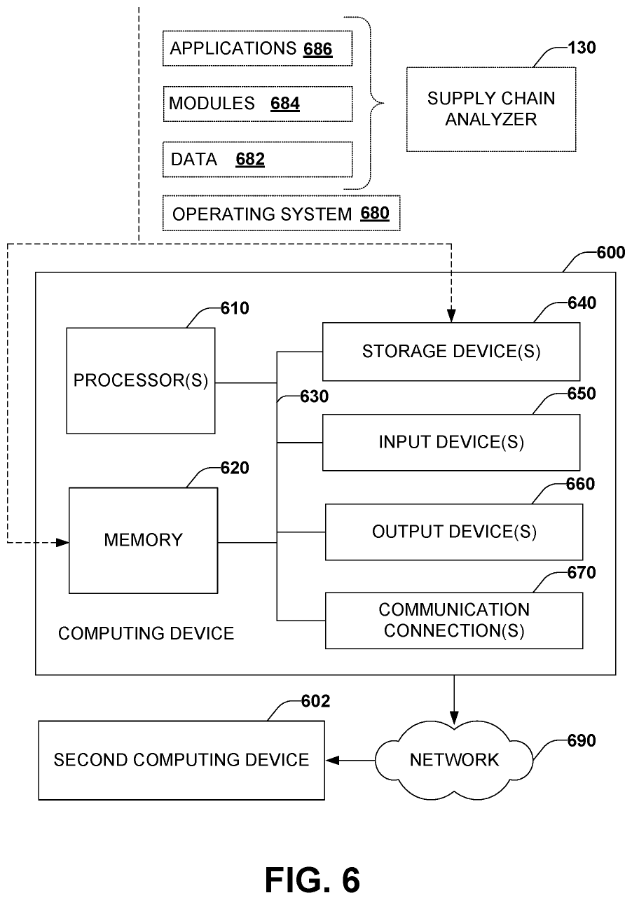

To provide a context for the disclosed subject matter, FIG. 6, as well as the following discussion, are intended to provide a brief, general description of a suitable environment in which various aspects of the disclosed subject matter can be implemented. The suitable environment, however, is solely an example and is not intended to suggest any limitation as to scope of use or functionality.

While the above-disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things, that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, server computers, as well as personal computers, hand-held computing devices (e.g., personal digital assistant (PDA), smart phone, tablet, watch), microprocessor-based or programmable consumer or industrial electronics, and the like. Aspects can also be practiced in distributed computing environments where tasks are performed by remote processing devices that are linked through a communications network. However, some, if not all aspects, of the disclosed subject matter can be practiced on stand-alone computers. In a distributed computing environment, program modules can be located in one or both of local and remote memory devices.

With reference to FIG. 6, illustrated is an example computing device 600 (e.g., desktop, laptop, tablet, watch, server, hand-held, programmable consumer or industrial electronics, set-top box, game system, compute node . . . ). The computing device 600 includes one or more processor(s) 610, memory 620, system bus 630, storage device(s) 640, input device(s) 650, output device(s) 660, and communications connection(s) 670. The system bus 630 communicatively couples at least the above system constituents. However, the computing device 600, in its simplest form, can include one or more processors 610 coupled to memory 620, wherein the one or more processors 610 execute various computer-executable actions, instructions, and or components stored in the memory 620.

The processor(s) 610 can be implemented with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. The processor(s) 610 can also be implemented as a combination of computing devices, for example, a combination of a DSP and a microprocessor, a plurality of microprocessors, multi-core processors, one or more microprocessors in conjunction with a DSP core, or any other such configuration. In one embodiment, the processor(s) 610 can be a graphics processor unit (GPU) that performs calculations with respect to digital image processing and computer graphics.

The computing device 600 can include or otherwise interact with a variety of computer-readable media to facilitate control of the computing device to implement one or more aspects of the disclosed subject matter. The computer-readable media can be any available media that is accessible to the computing device 600 and includes volatile and nonvolatile media, and removable and non-removable media. Computer-readable media can comprise two distinct and mutually exclusive types, namely storage media and communication media.

Storage media includes volatile and nonvolatile, removable, and non-removable media implemented in any method or technology for storage of information such as computer-readable instructions, data structures, program modules, or other data. Storage media includes storage devices such as memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other like mediums that store, as opposed to transmit or communicate, the desired information accessible by the computing device 600. Accordingly, storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

The memory 620 and storage device(s) 640 are examples of computer-readable storage media. Depending on the configuration and type of computing device, the memory 620 can be volatile (e.g., random access memory (RAM)), nonvolatile (e.g., read only memory (ROM), flash memory) or some combination of the two. By way of example, the basic input/output system (BIOS), including basic routines to transfer information between elements within the computing device 600, such as during start-up, can be stored in nonvolatile memory, while volatile memory can act as external cache memory to facilitate processing by the processor(s) 610, among other things.

The storage device(s) 640 include removable/non-removable, volatile/nonvolatile storage media for storage of vast amounts of data relative to the memory 620. For example, storage device(s) 640 include, but are not limited to, one or more devices such as a magnetic or optical disk drive, floppy disk drive, flash memory, solid-state drive, or memory stick.

Memory 620 and storage device(s) 640 can include, or have stored therein, operating system 680, one or more applications 686, one or more program modules 684, and data 682. The operating system 680 acts to control and allocate resources of the computing device 600. Applications 686 include one or both of system and application software and can exploit management of resources by the operating system 680 through program modules 684 and data 682 stored in the memory 620 and/or storage device(s) 640 to perform one or more actions. Accordingly, applications 686 can turn a general-purpose computer 600 into a specialized machine in accordance with the logic provided thereby.

All or portions of the disclosed subject matter can be implemented using standard programming and/or engineering techniques to produce software, firmware, hardware, or any combination thereof to control the computing device 600 to realize the disclosed functionality. By way of example and not limitation, all or portions of the scheduler 110 can be, or form part of, the application 686, and include one or more modules 684 and data 682 stored in memory and/or storage device(s) 640 whose functionality can be realized when executed by one or more processor(s) 610.

In accordance with one particular embodiment, the processor(s) 610 can correspond to a system on a chip (SOC) or like architecture including, or in other words integrating, both hardware and software on a single integrated circuit substrate. Here, the processor(s) 610 can include one or more processors as well as memory at least similar to the processor(s) 610 and memory 620, among other things. Conventional processors include a minimal amount of hardware and software and rely extensively on external hardware and software. By contrast, an SOC implementation of a processor is more powerful, as it embeds hardware and software therein that enable particular functionality with minimal or no reliance on external hardware and software. For example, the scheduler 110 and/or functionality associated therewith can be embedded within hardware in a SOC architecture.

The input device(s) 650 and output device(s) 660 can be communicatively coupled to the computing device 600. By way of example, the input device(s) 650 can include a pointing device (e.g., mouse, trackball, stylus, pen, touch pad), keyboard, joystick, microphone, voice user interface system, camera, motion sensor, and a global positioning satellite (GPS) receiver and transmitter, among other things. The output device(s) 660, by way of example, can correspond to a display device (e.g., liquid crystal display (LCD), light emitting diode (LED), plasma, organic light-emitting diode display (OLED) . . . ), speakers, voice user interface system, printer, and vibration motor, among other things. The input device(s) 650 and output device(s) 660 can be connected to the computing device 600 by way of wired connection (e.g., bus), wireless connection (e.g., Wi-Fi, Bluetooth), or a combination thereof.

The computing device 600 can also include communication connection(s) 670 to enable communication with at least a second computing device 602 by means of a network 690. The communication connection(s) 670 can include wired or wireless communication mechanisms to support network communication. The network 690 can correspond to a local area network (LAN) or a wide area network (WAN) such as the Internet. The second computing device 602 can be another processor-based device with which the computing device 600 can interact. For example, the computing device 600 can correspond to a server that executes functionality of the scheduler 110, and the second computing device 602 can be a user device that communicates and interacts with the computing device 600.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A system, comprising:
a processor coupled to a memory that includes instructions that, when executed by the processor, cause the processor to:
request historical transaction data of a merchant from a financial institution database;
compute a historical transaction rate from the historical transaction data;
generate a pricing model based on the historical transaction data and historical transaction rate that correlates item price with the historical transaction rate;
determine a current transaction rate from real-time transaction data;
invoke the pricing model with a current pricing schedule and the current transaction rate to produce an updated pricing schedule for the merchant that adjusts one or more prices to achieve a predetermined target transaction rate; and
implement the updated pricing schedule with the merchant on a merchant computing device.

2. The system of claim 1, wherein the pricing model is a machine learning model to infers the updated pricing schedule that is likely to achieve the predetermined target transaction rate.

3. The system of claim 1, wherein variance between the current pricing schedule and the updated pricing schedule is constrained to a predetermined amount.

4. The system of claim 1, wherein the updated pricing schedule is confined by one or more of a predetermined minimum or predetermined maximum price.

5. The system of claim 1, wherein the updated pricing schedule provides different pricing for a set of items offered by the merchant based on a time of day.

6. The system of claim 1, wherein the instructions further cause the processor to continuously update the pricing schedule with the pricing model until the target transaction rate is achieved.

7. The system of claim 1, wherein the target transaction rate is a constant transaction rate during business hours.

8. The system of claim 1, wherein the instructions further cause the processor to update the pricing model with the current pricing schedule and the current transaction rate.

9. The system of claim 1, wherein the merchant computing device is a digital display that presents prices of items provided by the merchant.

10. A method, comprising:
executing, on a processor, instructions that cause the processor to perform operations, the operations comprising:
requesting historical transaction data of a merchant from a financial institution database;
computing a historical transaction rate from the historical transaction data;
generating a pricing model based on the historical transaction data and historical transaction rate that correlates item price with the historical transaction rate;
determining a current transaction rate from real-time transaction data;
invoke the pricing model with a current pricing schedule and the current transaction rate to produce an updated pricing schedule for the merchant that adjusts one or more prices to achieve a predetermined target transaction rate; and
implementing the updated pricing schedule with the merchant on a merchant computing device.

11. The method of claim 10, wherein the operations further comprise generating a machine-learning-based pricing model.

12. The method of claim 10, wherein the operations further comprising invoking the pricing model with a variance constraint that restricts variance between the current pricing schedule and the updated pricing schedule to a predetermined amount.

13. The method of claim 10, wherein the operations further comprise invoking the pricing model with a predetermined minimum or predetermined maximum price constraint.

14. The method of claim 10, wherein the operations further comprise continuously updating the pricing schedule with the pricing model until the target transaction rate is achieved.

15. The method of claim 10, wherein the operations further comprise updating the pricing model with the current pricing schedule and the current transaction rate.

16. The method of claim 10, wherein the operations further comprise implementing the updated pricing schedule on a digital display that presents prices of items provided by the merchant.

17. A computer-implemented method, comprising:
determining a current transaction rate from real-time transaction data of a merchant;
comparing the current transaction rate with a target transaction rate;
executing a pricing model with a current pricing schedule and a current transaction rates as input to update the pricing schedule for the merchant by adjusting one or more prices to achieve a predetermined target transaction rate, wherein the pricing model correlates item price with historical transaction rates and execution of the pricing model is triggered when a result of the comparing satisfies a threshold difference; and
implementing the pricing schedule with the merchant on a merchant computing device.

18. The method of claim 17, further comprising:
determining contact information for a set of customers associated with the merchant; and
sending a notification to the contact information of the set of customers, wherein the notification includes an offer based on the pricing schedule.

19. The method of claim 18, wherein the notification is a targeted advertisement to the set of customers by way of a social media message.

20. The method of claim 17, further comprising:
interfacing with a delivery service application, wherein the delivery service application includes a set of items provided by the merchant; and
updating the delivery service application with the pricing schedule for the set of items.
